(19) United States
(12) Patent Application Publication
(10) Pub. No.: US 2004/0056368 A1
(43) Pub. Date: Mar. 25, 2004

(54) Liquid organometallic compound vaporizing/feeding system

(76) Inventors: Kazuhiro Hirahara, Niigata-ken (JP); Takanobu Tsudera, Niigata-ken (JP); Daisuke Iwai, Niigata-ken (JP)

Correspondence Address: BIRCH STEWART KOLASCH & BIRCH, PO BOX 747, FALLS CHURCH, VA, 22040-0747, US

(21) Appl. No.: 10/666,252

(22) Filed: Sep. 22, 2003

(30) Foreign Application Priority Data
Sep. 19, 2002 (JP) 2002-273083

(51) Int. Cl. F02M 1/00; C10K 1/08; F24F 3/14; B01D 47/00

(52) U.S. Cl. 261/64.3

(57) ABSTRACT

A liquid organometallic compound vaporizing and feeding system includes a container containing a liquid organometallic compound MO, a vaporizer for vaporizing MO, a liquid passageway connecting the container to the vaporizer and having a liquid MO mass flow controller, a carrier gas source, a carrier gas passageway connecting the source to the vaporizer and having a carrier gas mass flow controller, a sample gas passageway connecting the vaporizer to an ICP emission spectrometer and having an in-line monitor, a calibration standard gas cylinder, and a standard gas passageway connecting the cylinder to the sample gas passageway downstream of the in-line monitor and having a standard gas mass flow controller.

### TECHNICAL FIELD

This invention relates to a system for vaporizing and feeding a liquid organometallic compound to an inductively coupled plasma (ICP) emission spectrometer.

### BACKGROUND ART

As the crystal growth method of compound semiconductors, the metal organic chemical vapor deposition (MOCVD) method using liquid organometallic compounds is now of great interest. The MOCVD method is one of crystal growth means commonly employed in the manufacture of epitaxial thin films of compound semiconductors. The method starts with organometallic compounds such as (CH₃)₃Ga, (CH₃)₃In and (CH₃)₃Al as the reagents, and performs crystal growth to form a thin film utilizing the thermal decomposition reaction thereof.

Since the quality of semiconductor thin films produced by the MOCVD method largely depends on the chemical purity of organometallic compounds used as the reagents, a demand for organometallic compounds of higher purity has continuously been made from the early time when the technology was developed to the present.

However, organometallic compounds are difficult to handle because of very high chemical activity and toxicity. In the current circumstance, few methods have been established for the analysis of trace impurities in organometallic compounds.

Most of the methods for the analysis of trace impurities in organometallic compounds, which have been reported so far, use an ICP emission spectrometer as the analytical instrument. In terms of the form of organometallic compounds during the ICP measurement and the method and apparatus for introducing organometallic compounds into the ICP, the technology is generally classified into the following six methods as are known in the art.

(1) Hydrolytic method: An organometallic compound is hydrolyzed to form an aqueous solution which is nebulized into aerosol and fed to an ICP torch. See Journal of Crystal Growth, 77 (1986), pp. 47-54.

(2) Solution method: After an organometallic compound is diluted with a solvent such as xylene, the mixed solution is nebulized into aerosol and fed to an ICP torch. See ANALYST, May 1990, Vol. 115.

(3) Flow injection method: Once an adduct is formed by mixing an organometallic compound with diethyl ether, it is passed through a nebulizer to form aerosol. The aerosol is then introduced into a membrane drying tube where diethyl ether is removed out of the system and only the remaining organometallic compound is fed to an ICP torch. See Spectrochimica Acta, Vol. 44B, No. 10, pp. 1041-1048, 1989.

(4) Electrothermal vaporization method: An organometallic compound is placed in a heater capable of instantaneously heating to a temperature of about 3,000° C. The vapor of organometallic compound thus generated is carried by a carrier gas and introduced directly into an ICP torch. See Journal of Analytical Atomic Spectrometry, December 1994, Vol. 9.

(5) Direct vapor introduction method: A carrier gas is blown into an organometallic compound filled in a stainless steel container, and the resulting vapor of organometallic compound is introduced directly into an ICP torch. See Journal of Electronic Materials, Vol. 18, No. 5, 1989.

(6) Exponential dilution method: A predetermined amount of organometallic compound is placed in a heater where it is heated to generate a vapor thereof, which is introduced directly into an ICP torch along with a carrier gas. See European Patent Application EP 0447747A2.

The above six methods each have advantages and disadvantages. None of them are regarded as a completed method for the analysis and introduction to ICP of organometallic compound. And yet, the exponential dilution method (6) is believed relatively superior for the reasons that (i) pre-treatment of organometallic compound is unnecessary, (ii) high sensitivity analysis is possible since organometallic compound can be analyzed without dilution, (iii) there is no change with time of the concentration of impurities, and (iv) only a minute quantity of a sample is necessary for measurement.

On use, however, the exponential dilution method has several problems because it is necessary to sample an organometallic compound from a container filled therewith, using a dispenser such as a syringe. (i) There is a possibility of human damage as by poisoning or burn during the sampling operation and introduction into a heater. (ii) The organometallic compound can be contaminated during the sampling operation. (iii) Sampling must be repeated on every analysis.

### SUMMARY OF THE INVENTION

An object of the present invention is to provide a liquid organometallic compound vaporizing and feeding system which ensures that an organometallic compound which is harmful to humans is manipulated in safety, and that ICP analysis is possible at very high sensitivity and with reproducibility using only minute quantities of expensive organometallic compound.

The present invention is directed to a liquid organometallic compound vaporizing and feeding system comprising (1) a liquid reagent passageway which connects a liquid reagent container containing a liquid organometallic compound to a vaporizer for vaporizing the liquid reagent via a liquid mass flow controller for controlling the flow rate of the liquid reagent, (2) a carrier gas passageway which connects a carrier gas source to the vaporizer via a carrier gas mass flow controller, and (3) a sample gas passageway which is connected to a sample inlet of an ICP emission spectrometer via an in-line monitor disposed downstream of the vaporizer. A standard gas passageway having a gas mass flow controller disposed therein for controlling the flow rate of a standard gas for calibration is connected to the sample gas passageway. This construction eliminates the cumbersome and dangerous operation of sampling the liquid organometallic compound by means of a dispenser such as a syringe, significantly increasing the safety to humans and avoiding the risk of contamination during the sampling operation. ICP analysis using only minute quantities of expensive organometallic compound is possible at very high sensitivity and in a reproducible manner. With the liquid organometallic compound vaporizing and feeding system of the invention, a plurality of standard gases for calibration can be generated at the same time, and quantitative and qualitative analyses of a wide variety of impurities instantaneously performed. As a result, very high sensitivity ICP analysis is possible in a highly safe and reproducible manner.

According to the present invention, there is provided a liquid organometallic compound vaporizing and feeding system comprising

(1) a liquid reagent container containing a liquid organometallic compound, a vaporizer for vaporizing the liquid organometallic compound, a liquid reagent passageway connecting the container to the vaporizer and having a liquid mass flow controller disposed therein for controlling the flow rate of the liquid organometallic compound,

(2) a carrier gas source, a carrier gas passageway connecting the carrier gas source to the vaporizer and having a gas mass flow controller disposed therein for controlling the flow rate of the carrier gas,

(3) a sample gas passageway including one end connected to a gas outlet of said vaporizer and another end connected to a sample inlet of an ICP emission spectrometer, and having an in-line monitor disposed therein,

(4) a gas cylinder filled with a standard gas for calibration, and a standard gas passageway connecting the gas cylinder to the sample gas passageway at a position downstream of the in-line monitor and having a gas mass flow controller disposed therein for controlling the flow rate of the standard gas.

In one preferred embodiment, the vaporizing and feeding system comprises a plurality of calibration standard gas cylinders, and a corresponding plurality of standard gas passageways each having a gas mass flow controller disposed therein for controlling the flow rate of the corresponding standard gas.

### BRIEF DESCRIPTION OF THE DRAWINGS

FIG. 1 is a schematic block diagram illustrating a vaporizing/feeding system according to a first embodiment of the invention.

FIG. 2 is a schematic illustration of a two-throw block valve which can be used in the system of FIG. 1.

FIG. 3 is a schematic illustration of another two-throw block valve which can be used in the system of FIG. 1.

FIG. 4 is a schematic block diagram illustrating a portion of the vaporizing/feeding system according to a second embodiment of the invention.

### DESCRIPTION OF THE PREFERRED EMBODIMENTS

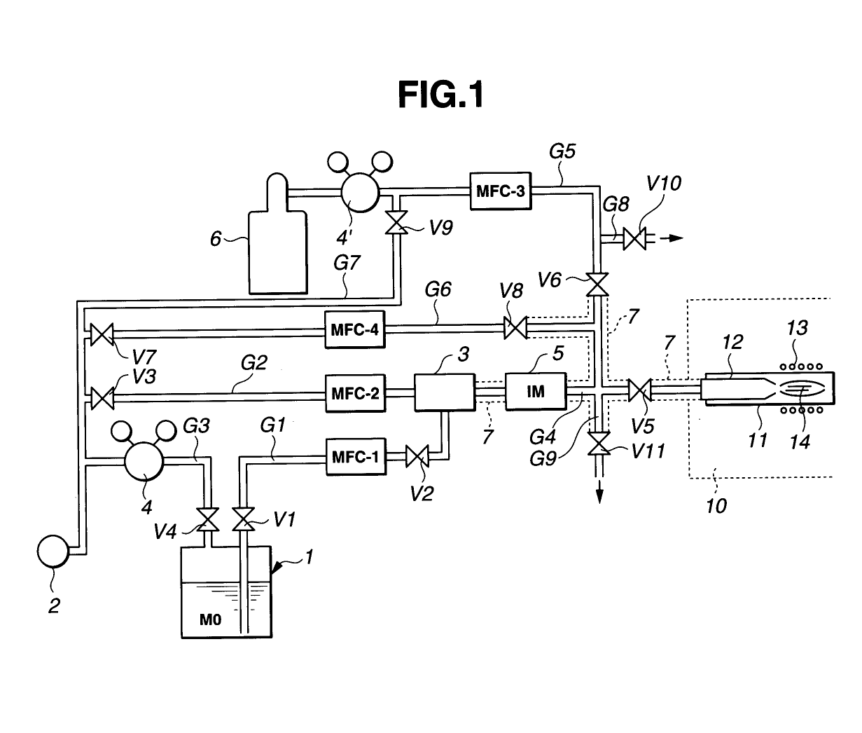

Referring to FIG. 1, there is schematically illustrated a liquid organometallic compound vaporizing/feeding system according to a first embodiment of the invention. The system includes a liquid reagent container 1 containing a liquid organometallic compound (MO), a carrier gas source 2 of argon gas or the like, and a vaporizer 3. A liquid reagent passageway G1 connects the liquid reagent container 1 to the vaporizer 3 for fluid communication. A liquid mass flow controller MFC-1 for controlling the flow rate of the liquid organometallic compound is disposed in the passageway G1, and switching valves V1 and V2 are disposed in the passageway G1 upstream and downstream of the controller MFC-1, respectively. The end portion of the passageway G1 on the container 1 side is constructed as a dip tube having an end submerged in the liquid organometallic compound. The system also includes a carrier gas passageway G2 which connects the carrier gas source 2 to the vaporizer 3 for fluid communication. A gas mass flow controller MFC-2 for controlling the flow rate of the carrier gas is disposed in the carrier gas passageway G2, and a switching valve V3 is disposed in the passageway G2 upstream of the controller MFC-2. The system further includes a passageway G3 which connects the carrier gas source 2 to the container 1 for fluid communication. A pressure governor 4 and a switching valve V4 are disposed in the passageway G3 at upstream and downstream positions, respectively.

Associated with the vaporizing/feeding system is an inductively coupled plasma (ICP) emission spectrometer 10 which includes a plasma torch 11, an injector 12, and an RF coil 13 which cooperate to produce a plasma flame 14. A sample gas passageway G4 connects a gas outlet of the vaporizer 3 to a sample inlet of the ICP spectrometer 10. An in-line monitor 5 is disposed in the sample gas passageway G4, and a switching valve V5 disposed in the passageway G4 downstream of the monitor.

Further included in the system are a gas cylinder 6 filled with a standard gas for calibration and a standard gas passageway G5 which connects for fluid communication the gas cylinder 6 to the sample gas passage G4 at a position between the in-line monitor 5 and the switching valve V5. In the standard gas passageway G5, a pressure governor 4′, a gas mass flow controller MFC-3 for controlling the flow rate of the calibration standard gas, and a switching valve V6 are disposed in this order from the upstream side to the downstream side. A second carrier gas passageway G6 extends from the carrier gas source 2 to the standard gas passageway G5. More particularly, the second carrier gas passageway G6 has one end connected to the carrier gas source 2; a switching valve V7, a gas mass flow controller MFC-4 and a switching valve V8 are disposed in the second carrier gas passageway G6 in this order from the upstream side to the downstream side; and the second carrier gas passageway G6 has another end connected to the standard gas passageway G5 at a position downstream of the switching valve V6. A third carrier gas passageway G7 extends from the carrier gas source 2 to the standard gas passageway G5. More particularly, the third carrier gas passageway G7 has one end connected to the carrier gas source 2; a switching valve V9 is disposed therein; and the third carrier gas passageway G7 has another end connected to the standard gas passageway G5 at a position between the pressure governor 4′ and the mass flow controller MFC-3.

Further the system includes a purge passageway G8 which is branched from the standard gas passageway G5 at a position between the mass flow controller MFC-3 and the switching valve V6 and has a switching valve V10 disposed therein. In the illustrated embodiment, another purge passageway G9 is branched from the sample gas passageway G4 at a position between the in-line monitor 5 and the switching valve V5, and a switching valve V11 is disposed therein.

Within the vaporizer 3, a gas/liquid mixing section and a nozzle section are closely disposed. In the gas/liquid mixing section, the liquid organometallic compound is mixed with the carrier gas while controlling their flow rates. The gas/liquid mixture thus obtained is injected in spray form from the nozzle section for vaporizing the liquid organometallic compound. The vapor of organometallic compound resulting from such vaporization is taken out together with the carrier gas to a gas outlet conduit extending downstream of the nozzle section. The vaporizer 3 is also equipped with a heater (not shown) so as to ensure effective and steady vaporization of the organometallic compound into gas.

The in-line monitor 5 is a device of measuring the concentration of reagent through the sample gas passageway G4 for determining whether or not the concentration of reagent gas to be fed to the ICP spectrometer is at the preset value. The in-line monitor 5 has built therein an IR absorption cell and an IR detector, and the principle of measurement is such that the organometallic compound gas is passed through the IR absorption cell, the IR absorption characteristic of the gas is measured by the IR detector, and a concentration is computed therefrom. The organometallic compound gas whose concentration has been measured by the in-line monitor 5 is directly channeled through the sample gas passageway G4 to the ICP spectrometer 10.

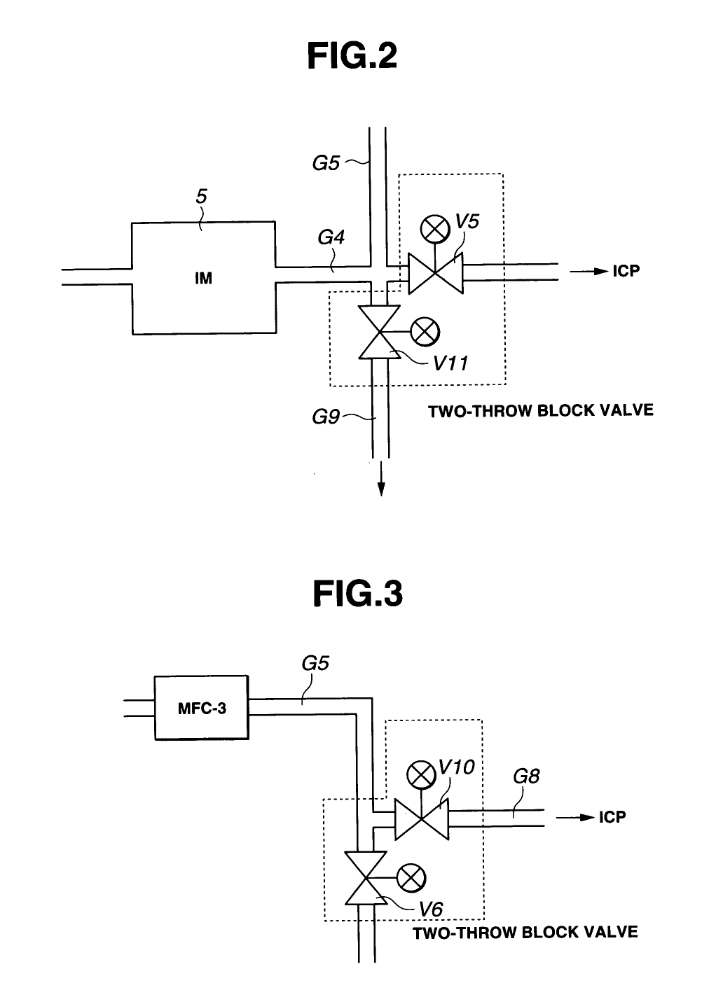

To further stabilize the concentration of the organometallic compound gas in the gas passageway, it is effective that the gas is purged through the passageway G9 for a certain period if necessary, with the valve V5 closed and the valve V11 opened. Upon switching of these valves, more or less pressure variations can occur. To reduce such pressure variations, a pneumatic two-throw block valve having switching valves V5 and V11 integrated together as shown in FIG. 2 is used. This enables instantaneous flowpath change without pressure variation.

The standard gas for calibration is necessary to quantitate the concentration of impurities remaining in the liquid organometallic compound (MO). It is prepared by diluting a compound containing the same elements as the impurities to be analyzed with high purity argon gas and precisely analyzing the gas concentration by a high performance analyzer such as an atmospheric pressure ionization-mass spectrometer (API-MS). The calibration standard gas is channeled through the passageway G5 having the mass flow controller MFC-3 to the ICP spectrometer 10, during which the flow rate of the gas to the ICP spectrometer can be arbitrarily changed by the mass flow controller MFC-3 whereby a calibration curve for the concentration of impurity to be analyzed (impurity concentration vs. ICP peak intensity) is plotted.

The compound which can be used in the calibration standard gas is preferably one which contains a target metal, has an appropriate vapor pressure, and does not undergo complex chemical changes even when a plurality of compounds are admixed. An exemplary preferred compound is tetramethylsilane when silicon is the impurity to be detected and tetramethylgermane when germanium is the impurity to be detected. The gas with which the compound is diluted is most preferably argon, and its concentration is typically 0.1 to 1,000 ppm, more typically 1 to 100 ppm. The calibration standard gas should be checked for a precise metal concentration by a high performance analyzer such as API-MS. As the calibration standard gas is channeled through the mass flow controller MFC-3 to the ICP spectrometer, the peak intensities corresponding to respective elements are measured. Using calibration curves of peak intensity vs. standard gas concentration, the concentrations of impurities in the organometallic compound gas can be accurately determined.

To further stabilize the concentration of the calibration standard gas in the gas passageway, it is effective that the gas is purged through the passageway G8 for a certain period if necessary, with the valve V6 closed and the valve V10 opened. Upon switching of these valves, more or less pressure variations can occur. To reduce such pressure variations, a pneumatic two-throw block valve having switching valves V6 and V10 integrated together as shown in FIG. 3 is used. This enables instantaneous flowpath change without pressure variation.

As the organometallic compound gas or calibration standard gas is channeled through a passageway conduit, the organometallic compound or metal species are adsorbed to the inner wall of the conduit. Such deposits can exert a memory effect to adversely affect the analytical results. To eliminate such influence, a heating means in the form of a tape heater 7 is preferably attached to a conduit section of passageway G4 extending from the vaporizer 3 to the in-line monitor 5, a conduit section of passageway G4 extending from the in-line monitor 5 to the ICP spectrometer 10, a conduit section of passageway G5 downstream of the switching valve V6, a conduit section of passageway G6 downstream of the switching valve V8, and a conduit section of passageway G9 upstream of the switching valve V11.

Also to instantaneously eliminate the memory effect of the calibration standard gas, a purge gas can be flowed along the passageway G6 via the switching valve V7, gas mass flow controller MFC-4 and switching valve V8.

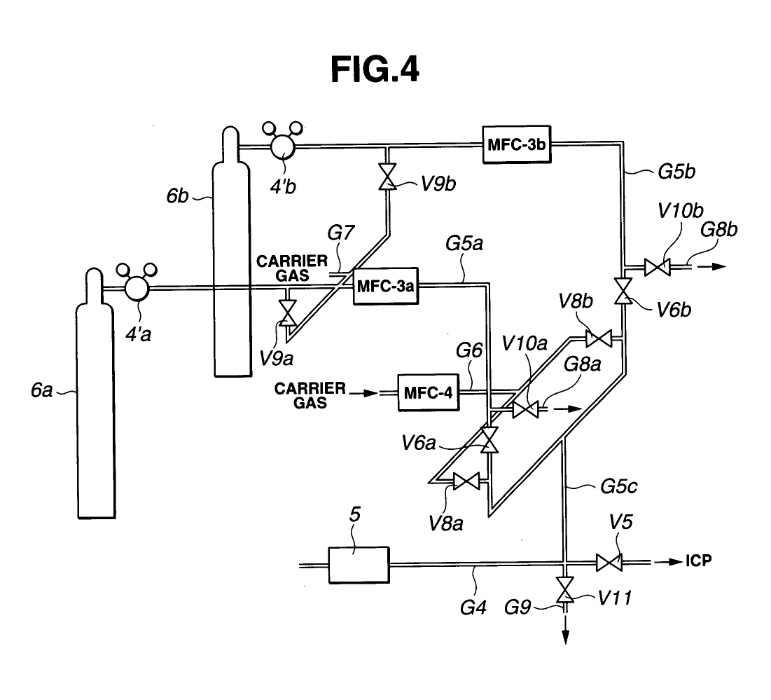

FIG. 4 illustrates a liquid organometallic compound vaporizing/feeding system according to a second embodiment of the invention. The system includes two gas cylinders 6a and 6b for containing two species of calibration standard gas, respectively. The gas cylinders 6a and 6b are connected to one ends of standard gas passageways G5a and G5b, which have pressure governors 4′a and 4′b, gas mass flow controllers MFC-3a and MFC-3b for controlling the flow rate of standard gas, and switching valves V6a and V6b, respectively. The other ends of standard gas passageways G5a and G5b are connected to one end of a standard gas feed passageway G5c which has another end connected to the sample gas passageway G4 at a position between the in-line monitor 5 and the switching valve V5. To the passageways G5a and G5b are connected passageways G6 and G7 having valves V8a, V8b, V9a and V9b. From the passageways G5a and G5b are branched purge passageways G8a and G8b having valves V10a and V10b. The rest of the system is the same as in FIG. 1.

It is understood that more than two species of calibration standard gas may be used, and in such a case, their cylinders are connected to a corresponding number of standard gas passageways.

Since the calibration standard gases correspond to the types of impurity to be analyzed, they are finally needed in the number of elements to be analyzed. For simplification of the system, a standard gas for multiple element calibration should be prepared by charging a single pressure container with all metal-containing compounds as subjects of measurement. However, some compounds can form non-volatile compounds or change to other compounds through chemical reaction. Then the compounds must be divided into certain groups each consisting of those compounds which remain intact even when mixed together. This necessitates a plurality of calibration standard gases and a corresponding plurality of feed passageways. With the manipulation of ICP and other factors taken into account, the number of calibration standard gases, the number of gas mass flow controllers or the number of gas passageways is desirably 2 to 5.

In the liquid organometallic compound vaporizing and feeding system according to either the first or second embodiment of the invention, it is recommended to use a conduit with a minimum length and an outer diameter of up to ⅛ inch for the liquid reagent passageway G1 extending from the liquid reagent container 1 filled with the liquid organometallic compound (MO) to the vaporizer 3 and a valve of smaller size for the main valve V1 located immediately downstream of the reagent container 1 because the dead volume within the liquid mass flow controller MFC-1, vaporizer 3, main valve V1 or liquid reagent passageway G1 can be minimized thereby.

In the liquid organometallic compound vaporizing and feeding system according to either the first or second embodiment of the invention, the flow rate of the liquid organometallic compound (MO) fed from the liquid mass flow controller MFC-1 to the vaporizer 3 is preferably 0.005 to 1 g/min, more preferably 0.01 to 0.1 g/min. The flow rate of the carrier gas fed to the vaporizer 3 is preferably 10 to 3,000 ml/min, more preferably 50 to 1,000 ml/min. The flow rate of the standard gas through the mass flow controller MFC-3 is preferably 0.1 to 100 ml/min, more preferably 1 to 10 ml/min.

Now the operation of the system is described. The switching valve V3 is opened, the carrier gas is passed through the carrier gas mass flow controller MFC-2 in which the flow rate has previously been set, and then the carrier gas is channeled from the vaporizer 3 to the ICP spectrometer through the gas passageway G4 and by way of the in-line monitor 5. The result of ICP measurement performed in this state is a blank.

The carrier gas is adjusted to a predetermined pressure by the pressure governor 4 and passed to the liquid reagent container 1 through the switching valve V4, thereby increasing the pressure within the container 1. If the main valve V1 is opened in this state, the liquid organometallic compound (MO) is displaced from the container 1 through the dip tube and main valve V1 toward the liquid mass flow controller MFC-1. If the switching valve V2 is opened, the liquid organometallic compound reaches the mass flow controller MFC-1 whereby flow rate control is initiated.

Then the liquid organometallic compound (MO) flows at a predetermined flow velocity through the passageway G1 to the vaporizer 3 where it is diluted and mixed with a large volume of the carrier gas which is channeled from the carrier gas source 2 by way of the gas mass flow controller MFC-2. At the same time in the vaporizer 3, the organometallic compound is instantaneously heated to a predetermined temperature, typically 150° C. and thus completely vaporized. The organometallic compound gas is then channeled at a high velocity to the in-line monitor 5 through the passageway G4.

The in-line monitor 5 measures the concentration of organometallic compound gas diluted and mixed with the carrier gas and determines whether the concentration is a predetermined concentration. The organometallic compound gas exiting from the in-line monitor 5 is introduced to the ICP spectrometer 10 through the passageway G4 and by way of the switching valve V5.

To accurately quantitate the amount of an impurity in the organometallic compound gas, the calibration standard gas can be introduced to the ICP spectrometer 10 by way of the mass flow controller MFC-3 and through the passageways G5 and G6.

The liquid organometallic compound (MO) of interest in ICP analysis is not particularly limited as long as it is used as a reagent for MOCVD. The invention is effective in microanalysis for so-called compound semiconductor materials such as III-V Group and II-VI Group semiconductors.

Illustrative non-limiting examples of organometallic compounds include trimethyl (or ethyl) gallium, trimethyl (or ethyl) indium, trimethyl (or ethyl) aluminum, dimethyl (or ethyl) zinc, tert-butyl phosphine, and tert-butyl arsine. All liquid organometallic compounds, organic compounds, metal hydrides and metal halides are analytes as long as they have any vapor pressure at normal temperature and atmospheric pressure. It is understood that analysis is essentially impossible if a metal impurity as a subject of measurement has no vapor pressure and cannot be transported by the carrier gas.

Described below is an example wherein the system is operated.

First, the plasma torch of ICP-AES is ignited, confirming steady burning of a plasma. The switching valve V5 is opened, and the carrier gas (argon) is channeled at a flow rate controlled by the gas mass flow controller MFC-2. The flow rate of the carrier gas is set at a level of 500 to 700 ml/min necessary for the argon plasma to continue steady burning. At this time, the carrier gas is channeled to the ICP spectrometer 10 by way of the vaporizer 3 and in-line monitor 5.

After the pressure governor 4 is set at a pressure of 2 kg/cm², the switching valve V9 is closed, the main valve V1 is opened, and thereafter, the main valve V4 is moderately opened. The switching valve V2 is opened in this state, immediately after which the liquid mass flow controller MFC-1 starts flow rate control to feed the liquid organometallic compound at a predetermined flow velocity to the vaporizer 3. Better results of analysis are obtained when the setting of the liquid mass flow controller MFC-1 is in a range of 0.01 to 0.1 g/min.

The liquid organometallic compound (MO) reaches the vaporizer 3 where it is diluted and mixed with a large volume of the carrier gas and instantaneously heated to 150° C. by a heater (not shown). The organometallic compound gas thus generated is transported at a high velocity to the in-line monitor 5 through the passageway G4. The organometallic compound gas, after measured for concentration by the in-line monitor 5, is introduced directly to the ICP through the gas passageway G4 and by way of the switching valve V5. To further stabilize the concentration of the organometallic compound gas within the gas passageway, it is effective that gas purging from the passageway G9 is performed for about 2 to 5 minutes, with the switching valve V5 closed and the switching valve V11 opened. Upon switching of these valves, more or less pressure variations can occur. To reduce such pressure variations, a pneumatic two-throw block valve having switching valves V5 and V11 integrated together as shown in FIG. 2 is used. This enables instantaneous flowpath change without pressure variation.

In this way, the organometallic compound gas whose concentration and flow rate are explicitly predetermined is fed to the ICP spectrometer. Then fast, high precision ICP analysis is possible with very high safety to humans.

The compound which can be used in the calibration standard gas may be a compound which contains a target metal, has an appropriate vapor pressure, and does not undergo complex chemical changes even when a plurality of compounds are admixed. An exemplary preferred compound is tetramethylsilane when silicon is the impurity to be detected and tetramethylgermane when germanium is the impurity to be detected. The gas with which the compound is diluted is most preferably argon, and its concentration is typically 0.1 to 1,000 ppm, more typically 1 to 100 ppm. The calibration standard gas should be checked for a precise metal concentration by a high performance analyzer such as API-MS. As the calibration standard gas is channeled through the passageways G5 and G4 to the ICP spectrometer by way of the mass flow controller MFC-3, the peak intensities corresponding to respective elements are measured. Using calibration curves of peak intensity vs. standard gas concentration, the concentrations of impurities in the organometallic compound gas can be accurately determined.

To further stabilize the concentration of the calibration standard gas in the gas passageway, it is effective that the gas is purged through the passageway G8 for about 2 to 5 minutes, with the switching valve V6 closed and the switching valve V10 opened. Upon switching of these valves, more or less pressure variations can occur. To reduce such pressure variations, a pneumatic two-throw block valve having switching valves V6 and V10 integrated together as shown in FIG. 3 is used. This enables instantaneous flowpath change without pressure variation.

In the liquid organometallic compound vaporizing and feeding system of the invention, a liquid organometallic compound flowing from a reagent container is accurately measured and controlled for flow rate by a mass flow controller and then vaporized and mixed with a carrier gas in a vaporizer, and the concentration of the completely vaporized organometallic compound is confirmed by an in-line monitor. Thus the organometallic compound gas having an accurate concentration can always be introduced into the ICP spectrometer. Also since a calibration standard gas can be fed directly to the ICP spectrometer, qualitative and quantitative analyses can be performed in-line on the concentrations of impurities remaining in the organometallic compound gas. This eliminates the cumbersome and dangerous operation of sampling the liquid organometallic compound by means of a dispenser such as a syringe, significantly increasing the safety to humans and avoiding the risk of contamination during the sampling operation. ICP analysis using minute quantities of expensive organometallic compound is possible at very high sensitivity and in a reproducible manner.

Another advantage of the liquid organometallic compound vaporizing and feeding system of the invention is that since a plurality of standard gases for calibration can be generated at the same time, quantitative and qualitative analyses of a wide variety of impurities can be instantaneously performed. When such calibration standard gases are grouped into a few groups, chemical reaction between compounds used as the standard gases is prevented.

As a result, very high sensitivity ICP analysis is possible in a highly safe and reproducible manner.

Japanese Patent Application No. 2002-273083 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A liquid organometallic compound vaporizing and feeding system comprising
(1) a liquid reagent container containing a liquid organometallic compound, a vaporizer for vaporizing the liquid organometallic compound, a liquid reagent passageway connecting said container to said vaporizer and having a liquid mass flow controller disposed therein for controlling the flow rate of the liquid organometallic compound,
(2) a carrier gas source, a carrier gas passageway connecting said carrier gas source to said vaporizer and having a gas mass flow controller disposed therein for controlling the flow rate of the carrier gas,
(3) a sample gas passageway including one end connected to a gas outlet of said vaporizer and another end connected to a sample inlet of an ICP emission spectrometer, and having an in-line monitor disposed therein,
(4) a gas cylinder filled with a standard gas for calibration, and a standard gas passageway connecting said gas cylinder to said sample gas passageway at a position downstream of said in-line monitor and having a gas mass flow controller disposed therein for controlling the flow rate of the standard gas.

2. The vaporizing and feeding system of claim 1, comprising a plurality of calibration standard gas cylinders, and a corresponding plurality of standard gas passageways each having a gas mass flow controller disposed therein for controlling the flow rate of the corresponding standard gas.
